(19) United States
(12) Patent Application Publication
(10) Pub. No.: US 2009/0263026 A1
(43) Pub. Date: Oct. 22, 2009

(54) CONTENT ITEM PLACEMENT

(75) Inventors: Nicholas Verne, Balmain (AU); Mike Perrow, Sydney (AU); Gerard Ellis, Roseville (AU)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/105,413

(22) Filed: Apr. 18, 2008

(51) Int. Cl. G06K 9/62

(52) U.S. Cl. 382/209

(57) ABSTRACT

A content item, e.g., an icon or advertisement logo, is placed in a display environment (e.g., on a map) so that the content item does not intersect a feature, e.g., a street name or graphical representation of a landmark. The placement of the content item is facilitated at a variety of zoom levels so that as the scale of the features and/or the content item changes, the content item and the features do not overlap.

### BACKGROUND

This subject matter of this specification relates to information presentation.

The Internet facilitates easy access to on-line mapping systems for millions of people. These on-line mapping systems can provide detailed maps of geographic regions at a variety of zoom levels. Additionally, the dynamic nature of these on-line mapping systems can facilitate the targeted presentation of content, such as advertisements. For example, a coffee retailer can provide advertisements in the form of selectable icons that are rendered on a map page that is displayed on a client device, such as a computer. Mousing over the icon can reveal additional advertising information, such as the coffee retailer's business name and contact information, including the address. Preferably, the icon is displayed on the map at a location that is coincident or proximate to the address of the advertising entity.

The maps also include many underlying features, such as map labels, e.g., street names, park names, lake names, etc. When targeted content items are displayed, however, they may overlap the map features. The user may thus need to take corrective actions, such as adjusting a map zoom level or scrolling the map to reveal a feature of interest. This can degrade the user experience.

### SUMMARY

The subject matter of this specification relates to placement of content items, e.g., advertisements, in a display environment (e.g., on maps). The content can be placed so that a graphical representation of the content item, e.g., an icon or advertisement logo, does not intersect a feature, e.g., a street name or graphical representation of a landmark. The placement of the content item is facilitated at a variety of zoom levels at which an underlying content item (e.g., the map) is presented so that as the scale of the features and/or the content item changes, the content item and the features do not overlap.

In general, one aspect of the subject matter described in this specification can be embodied in a method that includes the actions of identifying a map location; identifying a label location based on the map location and a zoom level, the label location being associated with a map label; and determining a placement location for placement of a content item relative to the map location so that when the map is presented at the zoom level with the content item, the content item does not intersect the map label. Other embodiments of this aspect include corresponding methods, apparatus, and computer program products.

Another aspect of the subject matter described in this specification can be embodied in a method that includes the actions of identifying a map location on a map, the map location associated with a content item; identifying a zoom level at which the map is to be presented; requesting placement location data based on the map location and the zoom level, the placement location data defining a placement location for the content item relative to the map location so that when the map is presented at the zoom level with the content item, the content item does not intersect any map feature items that are presented on the map at the zoom level; if placement location data is received in response to the request, then providing the placement location data and the content item to a client device so that the client device can present the content item at the placement location on the map when the map is presented at the zoom level. Other embodiments of this aspect include corresponding methods, apparatus, and computer program products.

The details of one or more implementations of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram of an example online map advertising environment.

FIGS. 2A and 2B are examples of a map at different zoom levels and in which advertisements can be presented.

FIG. 3 is a block diagram of an example placement location system.

FIG. 4 is a flowchart of an example process of placing a content item on a map.

FIG. 5 is a flowchart of an example process of identifying a placement location on a map.

FIG. 6 is block diagram of an example computer system that can be used to facilitate positioning of content on online maps.

Like reference symbols in the various drawings indicate like elements.

### DETAILED DESCRIPTION

### Ø1.0 Overview

The subject matter of this specification relates to placement of content items, e.g., advertisements, in a display environment. In one specific example, content is placed so that a graphical representation of the content item, e.g., an icon or advertisement logo, does not intersect a map feature, e.g., a street name or graphical representation of a landmark. The placement of the content item is facilitated at a variety of zoom levels at which the map is presented so that as the scale of the map features and/or the content item changes, the content item and the map features do not intersect. While reference is made to placing items on maps, the methods, apparatus and computer programs described can be used in other display environments.

In one example, a business may desire to have its business logo displayed on a map at a location coincident with the business address, e.g., 123 Third Avenue. The business may be located adjacent to a public park and a monument, both of which are shown as map features that include a name and a graphical representation on the map. Additionally, the names of the streets may be displayed near the business location on the map. As a user zooms in or out from the map, the relative size of the map features, e.g., the text of the street names or other features names, may change in size relative to the scale of the map. Thus, at a first zoom level, the business logo may be displayed at several locations near the business address without intersecting any map features. Conversely, at a second zoom level, e.g., resulting from “zooming out” to a higher level than the first zoom level, the business logo may only be displayed at one location without intersecting any map features.

In some implementations, a data structure of placement location data records is used to facilitate the placement of content items on the map. A placement location data record can specify a map location and permissible locations at which a content item can be displayed. Each location can be stored in a placement location record that includes the location at which the content item can be displayed and the zoom level that specifies the zoom level at which the location may be used to display the content item. Many other data structures, however, can be used to facilitate the features described above. As can be understood from the following, the permissible locations where a content item can be displayed may change at different zoom levels.

### Ø1.1 Map Advertising

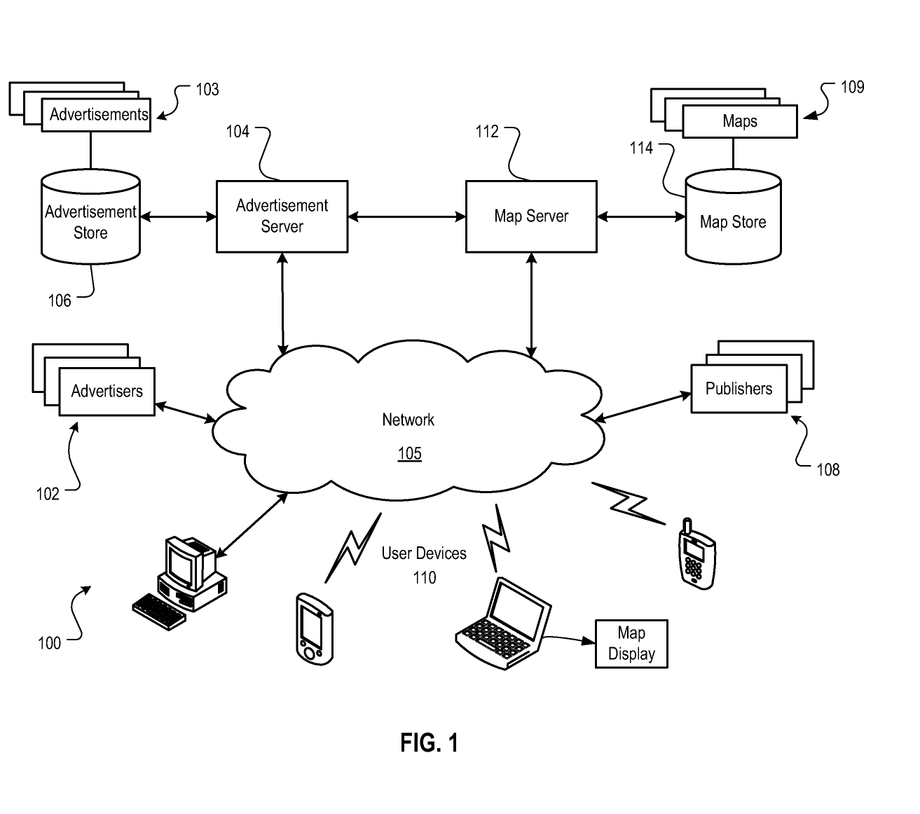

FIG. 1 is a block diagram of an implementation of an example online map environment 100. The map environment 100 can facilitate the serving of content items for display on a map. Although this specification uses advertisements as example content items and advertising servers as example content servers, many other content items can also be served and presented from other servers, such as icon links to video clips; information links or information snippets; picture links; etc.

In some implementations, advertisers 102 can connect to an advertisement server 104 to upload advertisements 103, track advertising statistics, bid for advertising space, or otherwise interact with the advertisement server 104. The advertisers 102 can connect to the advertisement server 104 through the network 105. The network 105 can be a wide area network, local area network, the Internet, or any other public or private network, or combination of both.

The advertisements 103, e.g. content items, may be in the form of graphical advertisements, text only advertisements, image advertisements, audio advertisements, video advertisements, advertisements combining one of more of any of such components, etc. The advertisements 103 may also include embedded information, such as links, meta-information, and/or machine executable instructions. The advertisements 103 can be formatted for presentation in maps 109. The advertisements 103 can be stored in an advertisement store 106 that is connected to the advertisement server 104.

The advertisements 103 can be displayed on a map 109 that is presented on a user device 110. The map can be requested directly from a map server 112 that provides a map user interface on a user device 100 when the user device 110 connects to the map server 112 and requests a map that is generated from map data stored in a map store 114.

Alternatively, the map 109 can be requested from a publisher 108 in response to a user device 110 requesting content from the publisher 108. Example publishers 108 can be network content providers that publish websites. The publishers 108 receive requests for content from the user devices 110 and present content in response to the requests. In response to requests, the publishers 108 can include maps 109 with the content, thereby allowing the user devices 110 access to maps 109 through the publisher's website.

For example, the publisher 108 may be a business entity and may provide a map to its location on the home page of the publisher 108. In response to the map request by the publisher 108, the map server 112 selects data for the requested map from the map store 114 for presentation, and provides the selected data to either the publisher 108 or the requesting user device 110.

User devices 110 can connect to the publishers' websites or the map server 112 through the network 105 utilizing any device capable of communicating in a computer network environment and displaying retrieved information. Example user devices 110 include a web-enabled handheld device, a mobile telephone, a set top box, a game console, a personal digital assistant, a navigation device, or a computer.

The request for a map 109 can also include or generate a request for advertisements 103. In these implementations, the map server 112 can request advertisements 103 from the advertisement server 104. The advertisements 103 selected for delivery to the map server 112 can be selected based on their association with the map 109 selected by the map server 112. For example, the advertisements 103 can be associated with the map 109 if the advertiser 102 has a retail location within the region of the map 109 selected.

In some implementations, the advertisements 103 are delivered to the map server 112 by the advertisement server 104. The advertisements 103 can be placed on the map 109 at a location representative of the location associated with the advertiser 102 (e.g., a map of the retail location of the advertiser). The advertisements 103 can be placed on the map 109 by presenting the advertisements 103 as overlays on the map 109.

To specify placement of an advertisement 103, an advertiser 102 or the map server 112 may associate a map location with the advertisement 103. An example location can be street address, or a latitude and longitude location, or any other data that can specify a location on the map 109. Because the map location associated with map advertisements is a strong signal as to where the advertisement 103 is to be presented on the map, in some implementations, the advertisements 103 are generally placed at the location on the map that is associated with the advertisement 103, or as nearby as possible.

In some implementations, the characteristics of the advertisements 103 are independent of the characteristics of the map 109 and a change affecting the display of the map 109 will not necessarily affect the display of the advertisement 103. For example, if the map 109 is displayed at a higher zoom level, the advertisement 103 will not necessarily be displayed at the higher zoom level; or, alternatively, may be displayed at an adjusted location.

However, when advertisements 103 are presented as overlays on the map 109 it is possible that the advertisements will be presented at a location that will cause the advertisements to overlap text that identifies map features (e.g., monuments, parks, cities, etc.). Overlapping of the map features can prevent a user from being able to identify the map feature. Such overlap of map features can reduce the utility of the map. Thus, a placement location can be identified that facilitates presentation of the advertisement 103 without overlapping map features, as discussed below.

### Ø2.0 Content Item Placement

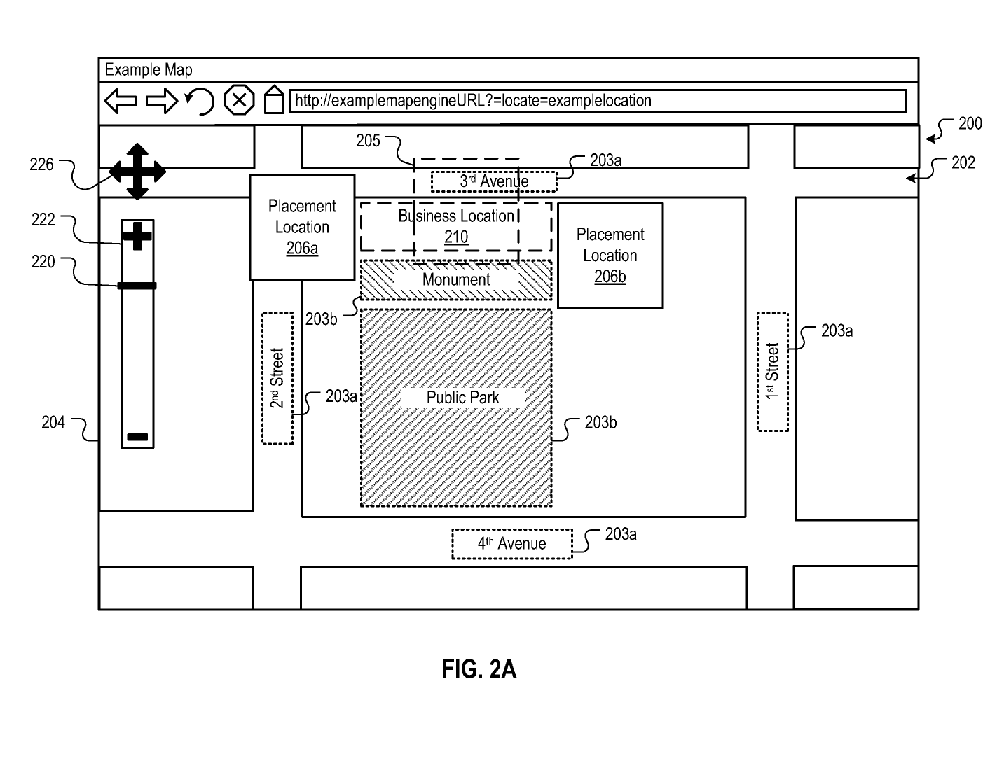

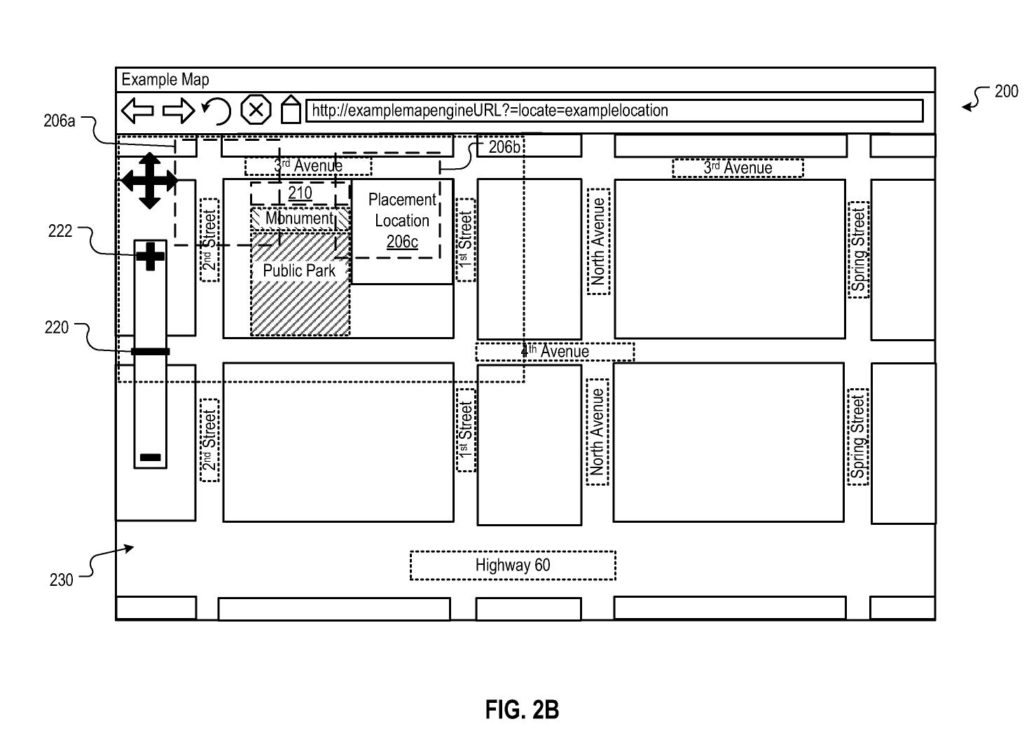

FIGS. 2A and 2B are examples of a map 200 at different zoom levels and in which advertisements can be presented. In particular, FIG. 2A depicts the map 200 at a first zoom level in a user interface window, such as a web browser window, and FIG. 2B depicts the map 200 at a second zoom level in the user interface window. The map 200 at the first zoom level shows a map space 202 that is the portion of the map 200, selected by the map server that can be displayed on a user device. In some implementations, the map space 202 is defined by a display region 204 and a zoom level. The display region 204 is the portion of the user's display that is allocated to present the map space 202. The zoom level represents the scaling of the map space 202 within the display region 204, and is graphically indicated by the position of a zoom bar 220 in a zoom control 222.

The map space 202 that is presented to the user device can include map feature items 203, such as text items 203a that identify features on the map and/or graphic items 203b, such as a public park icon or a monument icon, that graphically illustrate map features. The feature items 203 can be rendered as part of the map space 202.

The area that a feature item 203 occupies in the map space 202 can be defined by a bounded polygon, as indicated by the first dashed outline of each feature item 203. The bounded polygon can be, for example, a rectangle bounded region that establishes a border of the area occupied by the feature item 203. The bounded polygon can, for example, represent a conceptual border that is not visible to a user. In some implementations, the bounded polygons can be defined tangential to the bounds of the text, but the size of the bounded polygon can vary based on the application. The bounded regions can also define the bounds of graphical data, such as a green area (represented by shading lines) for the public park and a yellow area (represented by shading lines) for the monument.

Also depicted in the map space 202 is a map location 210, as indicated by a second dashed outline. In the example of FIGS. 2A and 2B, the map location 210 is a business location. In some implementations, a representation of the building in which the business is located may not be shown on the map space 202, and thus the second dashed outline is conceptual; in other implementations, a building outline in which the business is located may be shown, and thus the second dashed outline can be a building outline. The map location 210 can be a business address, e.g., “123 Third Avenue,” or can be a latitude and longitude coordinates, or any other identifier that represents the location on the map 200.

Other conventional map symbols, e.g., streets and city blocks, are illustrated by the conventional block and street symbols as shown in FIG. 2A. Some of these elements are omitted to avoid congestion of the drawings.

The owner of the business at the map location 210 may want to advertise on the map 200. Preferably these advertisements are displayed proximate to the map location, e.g., within one or two city blocks, depending on the selected zoom level. The advertisement can, for example, be a content item that defines a content item region, e.g., a selectable graphic having a height and width dimension, for example. In some implementations, placement location data is used to define placement locations, e.g., locations 206a and 206b, at which the advertisement can be placed without the region of the advertisement intersecting the bounded region of any feature item 203.

For example, if the business associated with the advertisement is located at the map location 210, then an advertisement that is the size of the outlined region 205 cannot be placed at the map location 210 without intersecting several feature items 203, i.e., an advertisement substantially the size of the outlined region 205 would overlap the street label “3^{rd} Avenue” and the “Monument” features 203 when the features 203 and the advertisement are displayed on a display device. However, the advertisement can be placed at either of placement locations 206a and 206b without intersecting any feature items.

In some implementations, each address for the map 200 can be processed to determine placement locations for content items that are available for that address. The placement locations may be determined based on the address, the maximum distance the content item is to be displayed from the address (e.g., a city block, a mile radius, etc.), the size of the bounded regions of feature items near the address, the size of the content item to be displayed, and the zoom level.

In other implementations, the placement locations 206 are associated with a map region. For example, map data can be partitioned into geographic units, e.g., sections of six city blocks. The placement locations may be determined, for example, based on the size of the bounded regions of feature items within the map region, the size of the content item to be displayed, and the zoom level.

Although only two placement locations (206a and 206b) are shown, more placement locations can be associated with the map location 210 or the map region surrounding the map location 210. Additional placement locations are not shown so as to avoid drawing congestion.

As previously described, the placement locations 206 that are available for advertisement presentation can depend on the zoom level of the map space 202. FIG. 2B depicts the map 200 at a lower zoom level, e.g., a “zoomed out” view relative to the view of FIG. 2A, as indicated by the adjusted of the zoom bar 220 in the zoom control 222.

At lower zoom level of FIG. 2B, a larger map space 230 is displayed in the user interface window. The maps space 230 includes the map space 202 that was presented in FIG. 2A, and which is identified by a dashed outline 202 in FIG. 2B. As the map space 202 of FIG. 2A only occupies a portion of the display region 204 in FIG. 2B, the portion of the map space 202 available for presenting the feature items 203 associated with the roads, monument, and public park has been scaled. Additionally, as the zoom level is manipulated, it is possible that feature items 203 presented in the map space 202 at a particular zoom level will appear at different locations in the map space 202 when a different zoom level is selected due to rendering algorithm decisions. For example, text may not be rendered below a minimum display font size to ensure readability; as the user “zooms out” of the map, the map may decrease in size while the display font size of a street name remains constant. Thus, feature items may change in size relative to the scale of the map space 202 as the scale of the map space is adjusted by a zoom operation.

Similarly, as the zoom level changes, the amount of detail displayed in the map space 202 also changes. These changes caused by the scaling at different zoom levels can result in a change of the available placement locations 206. For example, continuing with the advertisement placement example from FIG. 2A, when the map space 230 of FIG. 2B is presented, placement location 206c is the only placement location that is available for presentation of the advertisement. Placement location 206a and 206b, illustrated by the dashed locations 206a and 206b in FIG. 2B, are not available at the zoom level of FIG. 2B, as an advertisement placed at those locations would now overlap feature items displayed in the map space 230. Thus, placement locations 206 based on a map region, e.g., map space 202, or a map location, e.g., map location 210, can be defined for each advertisement at each zoom level.

### Ø3.0 Placement Location Identification

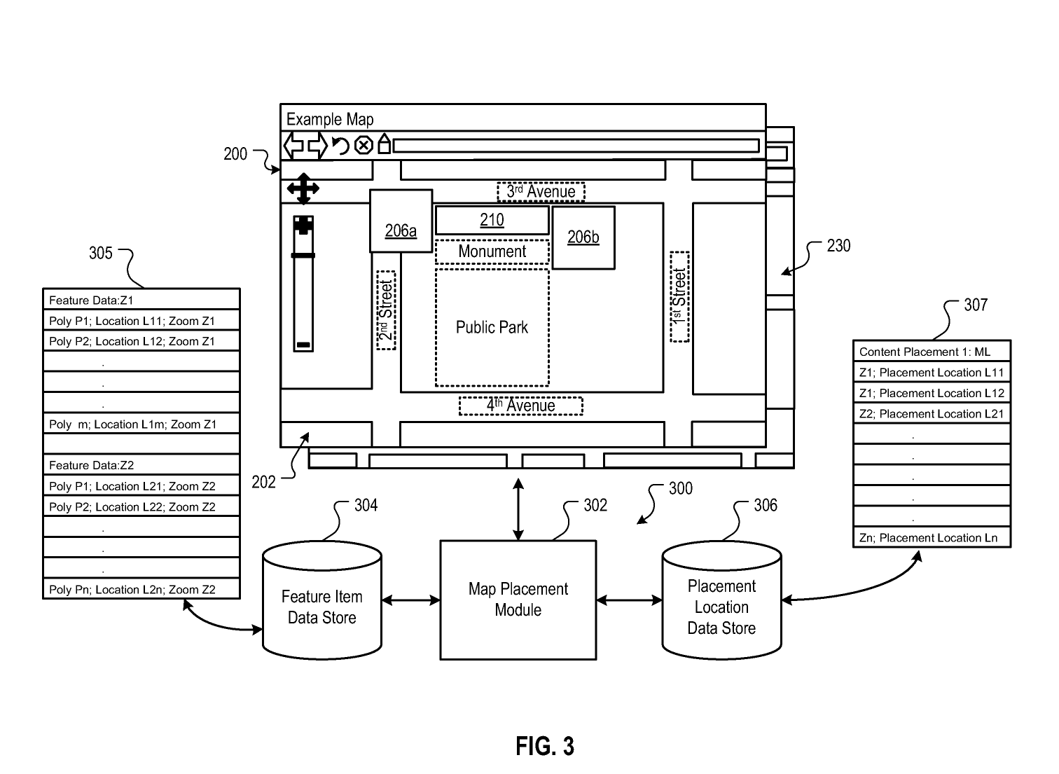

FIG. 3 is a block diagram of an example placement location system 300. The system 300 can be used to realize the features as discussed above, e.g., placement locations 206 for zoom levels and locations can be identified for advertisements so that the advertisements can be presented in a map space without overlapping feature items 203 that correspond to map features.

The system 300 can include a map placement module 302. The map placement module 302 can be implemented, for example, in the map server 112, as described in FIG. 1. The map placement module 302 is in data communication with a feature item data store 304 and a placement location data store 306. The feature item data store 304 and placement location store 306 can each be implemented, for example, in the map store 114, or in any other storage medium.

In some implementations, the map placement module 302 can identify placement locations 206 for advertisements based on the feature item data that is stored in the feature item data store 304. In turn, the map placement module 302 can store the placement locations in the placement location data store 306 and retrieve the stored data to facilitate placement of content items.

§3.1 Feature item Data Store

The feature item data store 304 can store feature item data that defines the feature items that are presented in a map space, such as the map space 202. For example, the feature item data can include information that identifies the location of the feature items 203. The location of the feature items 203 can be identified, for example, by the locations and areas of the bounded regions corresponding to the feature items 203. In some implementations, the location of a feature item 203 can be identified by a map location and data defining a surrounding boundary, e.g., coordinates relative to the map location.

As discussed above, the size and location of the feature items 203 that are presented, as well as which feature items 203 are presented can differ at each zoom level. Thus each feature item 203 in a particular geographic region may appear at different locations and/or different sizes in the geographic region when map spaces of different zoom levels are requested. Similarly, some of the feature items 203 may only appear at particular zoom levels. Thus, in some implementations, the feature item data store 304 can index the feature item data according to the zoom level and the geographic region or location in which the feature item is displayed.

The geographic region is a defined portion of the map. For example, a map can be divided into a grid, and each portion of the grid can correspond to a particular portion (e.g., geographic region) of the map. Including grid information with the feature item data facilitates identification of the feature items 203 that may be located in a particular geographic region. For example, given a location, feature items 203 that are in the same grid region can be identified, while feature items outside the grid region can be ignored.

An example feature item data structure 305 is illustrated in FIG. 3. Feature item data for two zoom levels, Z1 and Z2, are depicted. Each identified feature item at the first zoom level, Z1, is indexed by its location (e.g., Locations 11, 12 . . . 1m) and zoom level (e.g., Zoom Z1). Each identified feature item also includes bounded data (e.g., Poly P1, P2 . . . Pm) that define the bounded region of each feature item. For example, if the region represented by records 1-m for at the zoom level Z1 is the map space 202 of FIG. 2A, then data for Poly P1 may correspond to the feature item 203 that identifies Second Street in the map space 202, and location L11 can identify the location of the Second Street map label at when the map is display at the zoom level Z1. Likewise, the remaining records 2 . . . m can correspond to the remaining feature items shown in the map space 202.

Similarly, each identified feature item at the second zoom level, Z2, which corresponds to the zoom level of FIG. 2B, is identified and indexed by its location (e.g., Locations L21, L22 . . . L2n) and zoom level (e.g., Zoom Z2). Each identified feature item also includes bounded data (e.g., Poly P1, P2 . . . Pn) that define the bounded region of each feature item. Thus, if the region represented by records 1-n for at the zoom level Z2 is the map space 230 of FIG. 2B, then data for Poly P1 may correspond to the feature item 203 that identifies 2nd Street in the map space 230, and location L21 can identify the location of the 2nd Street label at when the map is display at the zoom level Z2. Likewise, the remaining records 2 . . . n can correspond to the remaining feature items shown in the map space 230.

### §3.2 Placement Location Data Store

The placement location data store 306 can store placement locations for content items at multiple zoom levels. In some implementations, the placement locations for a content item can be stored in a content placement data structure 307. Each content item can have an associated map location ML, and a plurality of placement location data stored in placement records. The placement location data are based on the map location ML and zoom level Z1 . . . Zq, and can define placement locations for the content item based on the map location ML so that when the map is presented at the zoom level with the content item, the content item does not intersect any map feature items that are presented on the map at the zoom level.

For example, location ML can correspond to the map location 210 shown in the map spaces 202 and 230 of FIGS. 2A and 2B. The records indexed by the zoom level Z1 and corresponding locations L11 and L12 can correspond to the locations 206a and 206b graphically depicted in the map space 202 of FIG. 2A. Likewise, the record indexed by the zoom level Z2 and corresponding location L21 can correspond to the location 206c graphically depicted in the map space 230 of FIG. 2B.

In some implementations, an advertisement can have a specified map location ML, e.g. the map location 210. The advertisement can be displayed at the map location or relative to the map location based on the associated placement location data and zoom levels.

In other implementations, the placement location data need not be pre-associated with a content item. For example, the placement location data can be used for any content item of a particular size, e.g., 32 pixels by 32 pixels, and the placement location data can be predetermined for many different locations ML, e.g., existing addresses; latitude and longitude coordinates, etc. The placement location data can be derived for a region surrounding each location, e.g., an area of nine adjacent city blocks; a 500 foot radius; etc. This particular implementation facilitates the placement of auctioned advertisements at multiple zoom levels so that the auctioned advertisements do not overlap feature items displayed on the map space.

### §3.3 Map Placement Module

The map placement module 302 is responsible for placing content items on the map space, and for determining placement location data.

### Ø3.3.1 Content Item Placement

The map placement module 302 can receive notification that a content item is to be placed on the map space and can identify the map location and the zoom level associated with the content item placement. The map location can be either pre-associated with the content item, such as a business address associated with a business advertisement for that business, or can be assigned to the content item as the result, for example, of an auction. In either case, the map placement module 302 queries the placement location data store 306 for a corresponding placement location at the zoom level at which the map space is to be displayed.

For example, when an advertisement is submitted to the advertisement server 104 of FIG. 1, the advertisement server 104 can provide information that identifies the map location 210 for the advertisement to the map placement module 302. The map placement module 302 can use the map location to identify the geographic region of the map for which feature item data is required. In turn, the map placement module 302 can retrieve placement location data for the geographic region from the placement location data store 306 as indexed by the zoom level at which the map is to be displayed. Thus, for the map location 210 at the zoom level Z1, the location data L11 and L12 would be retrieved. The advertisement could thus be placed at either of those locations. Likewise, for the map location 210 at the zoom level Z2, the location data L21 would be retrieved, and the advertisement would thus be placed at that location.

### Ø3.3.2 Generating Placement Location Data

In some implementations, the map placement module 302 can generate placement location data on an as-needed basis, e.g., in response to the serving of a content item. In other implementations, the map placement module 302 can generate placement location data in advance of any content item request. Both of these implementations can also be combined. After the placement location data is generated, it can be stored in the placement location data store 306.

In one implementation, the map placement module 302 can identify placement locations for a content item at each zoom level based on the feature item data, a location or a region, and the zoom level. The map placement module 302 can, for example, select a subset of the feature item data that is associated with a particular zoom level and map location, and determine which feature items 203 are near the map location 210 by comparing the feature item location data (e.g., L11, L12 . . . L1m) with the map location (e.g., location 210). Feature items within a maximum distance from the map location can be identified for evaluation. The maximum distance from the identified location can be, for example, as a specified number of pixels from the identified location (e.g., within 50 pixels of the identified location at the zoom level); a region (e.g., several city blocks), a radial distance (e.g., a 500 foot map radius); or some other distance that can be represented in the map space.

The map placement module 302 can then compare the location and an area that would be occupied by the content item if the content item was rendered at the location with the feature item locations and the area of bounded regions of the selected feature items. In some implementations, the map placement module 302 can first determine whether the advertisement can be placed at the map location 210 associated with the advertisement. For example, in one implementation, the map placement module 302 can determine whether any of the pixels required to present the advertisement will overlap with pixels required to present the selected feature items if the advertisement is placed at the map location 210.

If there is an overlap (e.g., either partial, substantial or complete) between the pixels required for the advertisement and any of the feature items as defined by the bounded data, then the map placement module 302 can search for a placement location near the map location where the advertisement can be presented without such overlap. In some implementations, the search can begin at locations that are nearest the map location 210 and progressively expand outward from the map location until a placement location is identified or until a maximum adjustment limit is reached. The maximum adjustment limit can be a region border; a city block limit; a distance; etc. In some implementations, all possible locations for a region are evaluated, and each location that is identified as a placement location is stored in the placement location data store 306.

In other implementations, the map placement module 302 can identify a content item region that defines a border of the content item, e.g., height and width dimensions of the content item. The bounded regions of the feature items in a region surrounding a location can be compared to the content item region at the location, and if all the bounded regions and the content item region do not intersect, then the location can be stored as a placement location in the placement location data store 306. Conversely, if any of the bounded regions of the feature items in the region surrounding the location intersect, then the location can be adjusted and the process can be repeated until a placement location is identified or until the maximum adjustment limit is reached. In some implementations, all possible locations for a region are evaluated, and each location that is identified as a placement location is stored in the placement location data store 306.

### §4.0 Example Process Flow

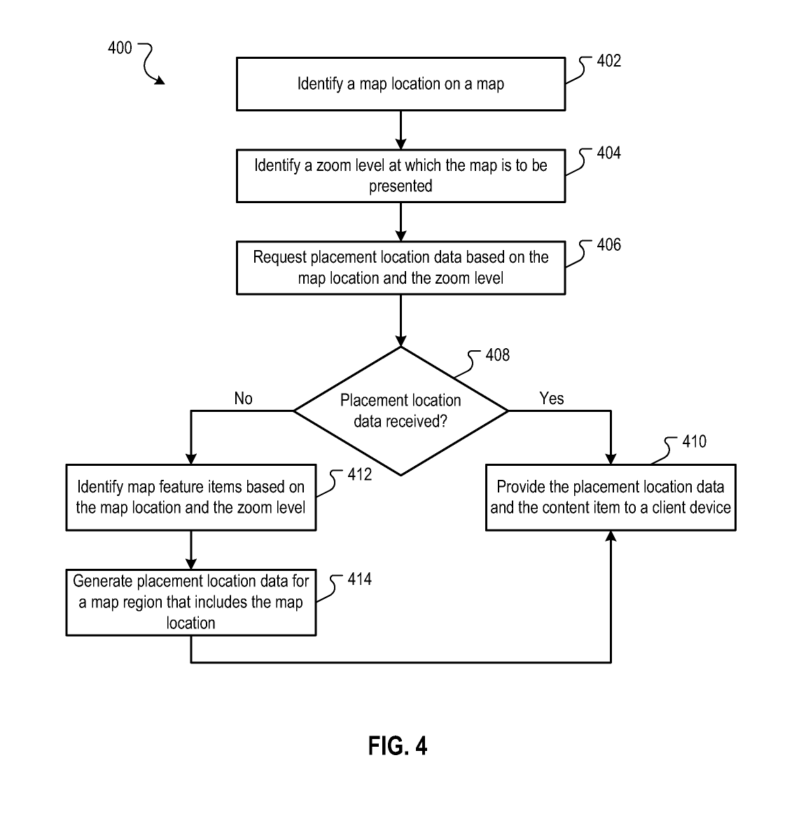

FIG. 4 is a flowchart of an example process 400 of placing a content item on a map. The process 400 can, for example, be used in the map server 112 of FIG. 1 and/or the map placement module 302 of FIG. 3.

Stage 402 identifies a map location on a map. For example, the map server 112 and/or the map placement module 302 can identify a map location on a map. The location can be associated with a content item, such as an advertisement.

Stage 404 identifies a zoom level at which the map is to be presented. For example, the map server 112 and/or the map placement module 302 can identify a zoom level at which a map is to be displayed. The zoom level can be identified in response to a map request from a client device.

Stage 406 requests placement location data based on the map location and the zoom level. For example, the map server 112 and/or the map placement module 302 can query the placement location data store 306 using the map location and the zoom level as input.

Stage 408 determines if placement location data is received in response to the request of stage 406. For example, the map server 112 and/or the map placement module 302 can determine if one or more placement locations, e.g., L11, L12, etc., are received from the placement location data store 306.

If placement location data is received, then stage 410 provides the placement location data and the content item to a client device. For example, the map server 112 and/or the map placement module 302 can provide the placement location data and the content item to the client device as presentation data so that when the map is presented at the zoom level, the content item is displayed at the placement location and does not overlap a map feature.

Conversely, if placement location data is not received, then stage 412 identifies map feature items based on the map location and the zoom level. For example, the map server 112 and/or the map placement module 302 can query the feature item data store 304 to identify feature item data, e.g., poly data P1 . . . Pm, location data L11 . . . L1m, for a zoom level Z1.

Stage 414 generates placement location data for a map region that includes the map location. For example, the map server 112 and/or the map placement module 302 can compare the bounded region at the feature item location to the content item region at the map location and determine if the bounded region and the content item region intersect. If the bounded region and the content item region do not intersect, then the map location can be stored as a placement location in the placement location data store. Conversely, if the regions do intersect, then the map location can be iteratively adjusted, and after each iterative adjustment the bounded region at the feature item location can be compared to the content item region at the map location until the regions do not intersect or until a maximum adjustment limit is reached.

The process then proceeds to stage 410, which then provides the placement location data and the content item to a client device. For example, the map server 112 and/or the map placement module 302 can provide a placement location generated in stage 414 and the content item to the client device so that when the map is presented at the zoom level, the content item is displayed at the placement location and does not overlap a map feature.

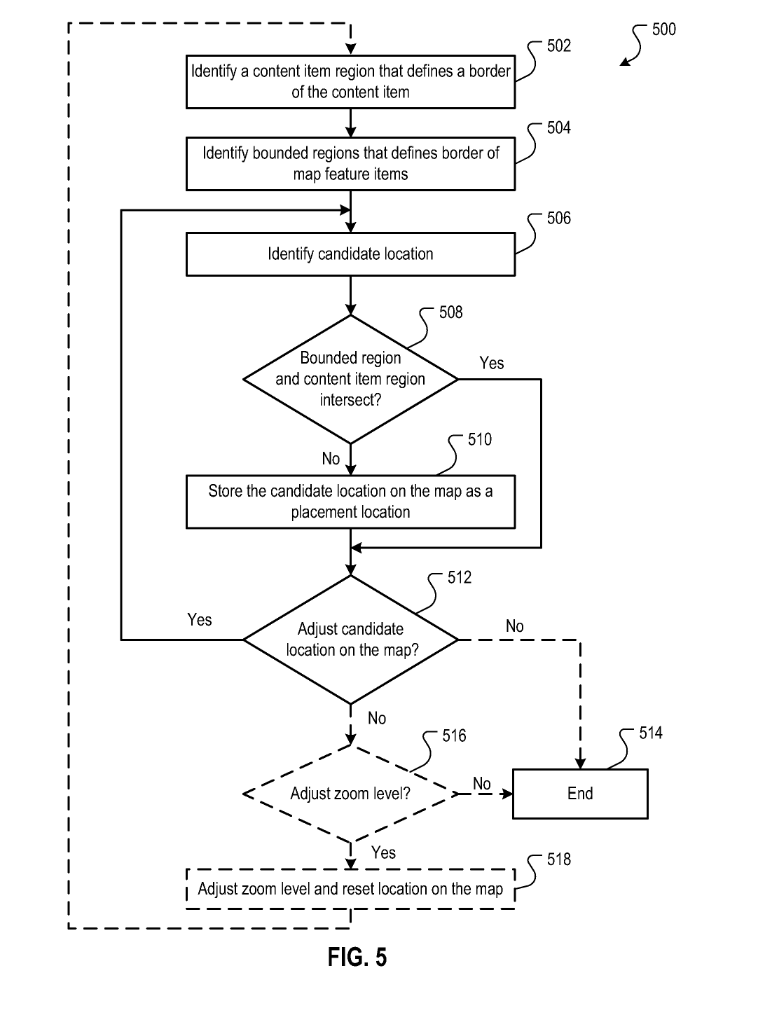

FIG. 5 is a flowchart of an example process 500 of identifying a placement location on a map. The process 500 can, for example, be used in the map server 112 of FIG. 1 and/or the map placement module 302 of FIG. 3. The process 500 can, for example, be used to implement stage 414 of FIG. 4.

Stage 502 identifies a content item region that defines a border of the content item. For example, the map server 112 and/or the map placement module 302 can identify a content item region that defines a border of an advertisement, such as a display element, e.g., a display box, that displays a creative or business logo.

Stage 504 identifies bounded regions that define borders of map feature items. For example, the map server 112 and/or the map placement module 302 can query the feature item data store 304 to identify feature item location data L11 . . . L1m and poly data P1 . . . Pm for a zoom level.

Stage 506 identifies a candidate location at which the content item region is to be located. For example, the map server 112 and/or the map placement module 302 can identify a location of a business entity, e.g., an address, or a nearby location, such as an adjusted location, as the candidate location.

Stage 508 determines if the bounded regions and any of the content item regions intersect. For example, the map server 112 and/or the map placement module 302 can compare the bounded regions P1, P2 . . . Pm respectively centered at locations L11, L12 . . . Lm to the content item region at a candidate location on the map. Based on the comparison, the map server 112 and/or the map placement module 302 can determine if any areas defined by the content item region and the bounded regions centered at their respective locations intersect.

If none of the bounded regions and the content item intersect, then stage 510 stores the candidate location on the map as a placement location. For example, the map server 112 and/or the map placement module 302 can store coordinates or other data identifying the location on the map in the placement data store, and index the location by the zoom level.

After stage 510, or if stage 508 determines that a bounded region and the content item do intersect, stage 512 determines if the candidate location of the content item should be adjusted. For example, the map server 112 and/or the map placement module 302 can examine multiple locations in a map region to identify all available placement locations by iteratively adjusting the location on the map and repeating stage 508.

If stage 512 determines the map location of the content item should be adjusted, then stage 514 adjusts the location and the process returns to stage 502, and all subsequent stages are then repeated with the adjusted location data. Conversely, if stage 512 determines if the map location of the content item should not be adjusted, then the process 500 ends at stage 516.

In some implementations, the process 500 can be repeated at different zoom levels. For example, the process 500 can be implemented to build a database of placement location data records during a preprocessing routine. In such implementations, stage 512 can proceed to stage 516, which determines if additional zoom levels should be processed. For example, the map server 112 and/or the map placement module 302 can be configured to process multiple zoom levels for a location on a map. If there are remaining zoom levels to be processed, the zoom level is adjusted; otherwise, the process 500 ends at stage 514.

If stage 516 determines that additional zoom levels should be processed, then stage 518 adjusts the zoom level and resets the location on the map to an original value. For example, the map server 112 and/or the map placement module 302 can adjust the zoom level to a second zoom level, e.g., Z2, and reset the location on the map to an original value, e.g., location 210. The process 500 then returns to stage 502.

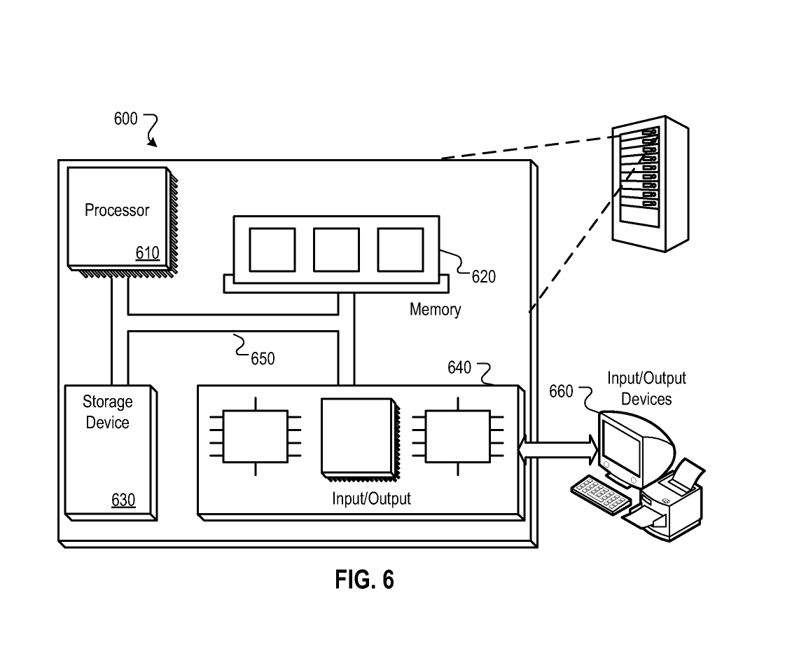

FIG. 6 is block diagram of an example computer system 600 that can be used to facilitate positioning of content on online maps. The system 600 includes a processor 610, a memory 620, a storage device 630, and an input/output device 640. Each of the components 610, 620, 630, and 640 can, for example, be interconnected using a system bus 660. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can, for example, include a hard disk device, an optical disk device, or some other large capacity storage device.

The input/output device 640 provides input/output operations for the system 600. In one implementation, the input/output device 640 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 660. Other implementations, however, can also be used, such as mobile computing devices, mobile communication devices, set-top box television client devices, etc.

The map placement module 300 can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium. The map placement module 300 can be distributively implemented over a network, such as a server farm, or can be implemented in a single computer device.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier for execution by, or to control the operation of, a processing system. The computer readable medium can be a machine readable storage device, a machine readable storage substrate, a memory device, a composition of matter effecting a machine readable propagated signal, or a combination of one or more of them.

The term “processing system” encompasses all apparatus, devices, and machines for processing data, including by way of example a programmable processor, a computer, or multiple processors or computers. The processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet. The computing system can include clients and servers. A client and server are generally remote from each other and typically interact through a communication network. The relationship of client and server arises by virtue of computer programs running on the respective computers and having a client server relationship to each other.

While this specification contains many specific implementation details, these should not be construed as limitations on the scope of any invention or of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A computer-implemented method, comprising:
identifying a map location;
identifying a feature location based on the map location and a zoom level, the feature location being associated with a map feature; and
determining a placement location for placement of a content item relative to the map location so that when the map is presented at the zoom level with the content item, the content item does not intersect the map feature.

2. The method of claim 1, wherein determining the placement location comprises:
identifying a bounded region that defines a border of the map feature at the feature location;
identifying a candidate location for the content item;
identifying a content item region that defines a border of the content item when the content item is placed at the candidate location; and
determining if the bounded region and the content item region intersect.

3. The method of claim 2, further comprising setting the placement location to the candidate location if the bounded region and the content item region are determined not to intersect.

4. The method of claim 2, further comprising:
iteratively adjusting the candidate location if the bounded region and the content item region are determined to intersect;
for each iterative adjustment, determining if the adjusted candidate location exceeds a maximum adjustment limit;
if the adjusted candidate location does not exceed the maximum adjustment limit:
determining if the bounded region and the content item region intersect when the content item is placed at the adjusted candidate location; and
setting the placement location to the adjusted candidate location if the bounded region and the content item region are determined not to intersect; and
if the adjusted candidate location does exceeds the maximum adjustment limit, then precluding presentation of the content item with the map at the zoom level.

5. The method of claim 2, wherein identifying the candidate location comprises identifying the map location on the map.

6. The method of claim 2, wherein identifying the map location comprises identifying a location on the map that is proximate to the map location.

7. The method of claim 1, further comprising providing presentation data to a client device, the presentation data including data defining the placement location and the content item and that causes the client device to present the content item at the placement location on the map when the map is presented at the zoom level.

8. The method of claim 1, wherein the content item is an advertisement.

9. A computer implemented method, comprising:
identifying a map location on a map, the map location associated with a content item;
identifying a zoom level at which the map is to be presented;
requesting placement location data based on the map location and the zoom level, the placement location data defining a placement location for the content item relative to the map location so that when the map is presented at the zoom level with the content item, the content item does not intersect any map feature items that are presented on the map at the zoom level; and
determining if placement location data is received in response to the request; and
if placement location data is received in response to the request, then providing the placement location data and the content item to a client device so that the client device can present the content item at the placement location on the map when the map is presented at the zoom level.

10. The method of claim 9, further comprising:
if placement location data is not received in response to the request, then:
identifying map feature items based on the map location and the zoom level, wherein each feature item defines a corresponding feature item area relative to a feature item location at the zoom level; and
generating the placement location data for a map region that includes the map location.

11. The method of claim 10, wherein the map region is a map tile.

12. The method of claim 9, further comprising:
upon determining that placement location data is not received in response to the request:
identifying a bounded region that defines a border of a map feature item;
identifying a content item region that defines a border of the content item when the content item is placed at the map location;
determining if the bounded region and the content item region intersect; and
storing the map location as a placement location if the bounded region and the content item region are determined not to intersect.

13. The method of claim 12, wherein the content item is an advertisement.

14. The method of claim 9, wherein the map feature item is a map label.

15. The method of claim 9, wherein the map feature item is an illustration of a geographic feature.

16. A system, comprising:
a placement location data store storing placement locations on a map, the placement locations being defined for a map region and zoom levels at which the map is to be presented; and
software stored in a computer readable medium and comprising instructions executable by a processing system and upon such execution cause the processing system to perform operations comprising:
identifying a map location on a map, the map location associated with a content item and defining a location within the map region;
identifying a zoom level at which the map is to be presented;
requesting placement location data based on the map location and the zoom level for use in defining a placement location for the content item so that when the map is presented at the zoom level with the content item, the content item does not intersect any map features that are presented on the map at the zoom level;
determining if placement location data is received in response to the request; and
if placement location data is received in response to the request, then providing the placement location data and the content item to a client device so that the client device can present the content item at the placement location on the map when the map is presented at the zoom level.

17. The system of claim 16, wherein the software comprises further instructions that upon execution cause the processing system to perform operations comprising:
upon determining that placement location data is not received in response to the request:
identifying map features based on the map location and the zoom level, wherein each map feature defines a corresponding map feature area relative to a map feature location at the zoom level; and
generating the placement location data for a map region that includes the map location; and
storing the placement location in the placement location data store.
